(19) United States
(12) Patent Application Publication
(10) Pub. No.: US 2023/0201982 A1
(43) Pub. Date: Jun. 29, 2023

(54) ADJUSTABLE FLUID MACHINING FIXTURE

(71) Applicant: NATIONAL CHUNG SHAN INSTITUTE OF SCIENCE AND TECHNOLOGY, Taoyuan City (TW)

(72) Inventors: KUEI-CHIH LI, Taoyuan City (TW); CHIEN-CHIH SHIH, Taoyuan City (TW); YI-CHERNG FERNG, Taoyuan City (TW); YING-SUN HUANG, Taoyuan City (TW); KUO-KUANG JEN, Taoyuan City (TW)

(21) Appl. No.: 18/084,580

(22) Filed: Dec. 20, 2022

(30) Foreign Application Priority Data
Dec. 28, 2021 (TW) 110149170

(51) Int. Cl. B23Q 3/06

(52) U.S. Cl. CPC B23Q 3/062; B23Q 2703/10

(57) ABSTRACT

An adjustable fluid machining fixture according to the present disclosure includes a base, having a clamping fixing seat which is used to clamp a workpiece to be machined; at least two guide blocks, disposed above the base and enveloping the workpiece to be machined once assembled to each other, each of the guide blocks provided with a fluid groove on one surface facing the workpiece to be machined, the respective fluid grooves of the guide blocks forming a fluid machining space once the guide blocks are assembled to each other; and at least two limiting units, disposed above the base, the limiting units used to fix the guide blocks and adjust fixed positions of the guide blocks on the base.

### CROSS-REFERENCE TO RELATED APPLICATION

This non-provisional application claims priority under 35 U.S.C. § 119(a) on Patent Application No(s). 110149170 filed in Taiwan, R.O.C. on Dec. 28, 2021, the entire contents of which are hereby incorporated by reference.

### BACKGROUND OF THE INVENTION

### 1. Field of the Invention

The present disclosure relates to a mechanical processing technique, and in particular to an adjustable fluid machining fixture for surface processing of an additive manufacturing finished product.

### 2. Description of the Related Art

Additive manufacturing applies computer aided design (CAD) software to process three-dimensional model data, and uses a powder material stacked in one layer after another to produce a three-dimensional object. In metal additive manufacturing, a CAD model file in a computer can be converted into a physical workpiece without particularly involving a mold, and a finished product can be directly completed. In addition, multiple workpieces can also be integrated according to specific customer requirements, and numerous structures of workpieces that cannot be easily accomplished by conventional manufacturing methods can be quickly made without having to worry about costly molds caused by manufacturing in small quantities. Therefore, metal additive manufacturing techniques provide features including integration of multiple parts, lightweight, adaptive flow path design and customization as advantages over conventional manufacturing techniques. Based on the above advantages, metal additive manufacturing accounts for one key technique in the current manufacturing of ultra-precision metal components, and effectively solves requirements of high-value molds, special metal components, complex structures and internal flow passages. Thus, metal additive manufacturing is gradually applied in the fields of aviation and aerospace. With improved quality of surfaces of workpieces of these fields, apart from preventing the issue of concentrated stress caused by surface defects of materials and reducing mechanical vibration and wear, the service life of materials of workpieces can also be prolonged. Hence, the aviation and aerospace industries demand higher precision sizes of workpieces made by metal additive manufacturing, and surface roughness quality of these workpiece is even more cautiously evaluated, especially for blade workpieces featuring complex torsion surfaces and thin plates. However, metal workpieces made by metal additive manufacturing techniques have quite rough surfaces (with Ra of approximately 10 μm to 15 μm). As a result, such surface processing techniques need to overcome issues of large roughness differences and difficulties in processing surfaces of workpieces.

Fluid machining devices are available in various forms such as a reciprocal type and a rotary type according to operating principles. In the reciprocal type, a workpiece is fixed in a machining cavity, and an abrasive having abrasive particles repeated flow in and flow out from two opposite ends through a surface of the workpiece on the inside, thereby achieving a machining effect. Fluid machining is a method of using pressure to squeeze a soft abrasive to send abrasive particles and a soft medium into a fixture. When the abrasive is squeezed back and forth in the fixture, the abrasive particles are rubbed (flexible contact) against a surface of a workpiece during the back and forth squeezing, further achieving a polishing effect. The most outstanding feature of fluid machining is the ability of polishing a part that cannot be reached by manual polishing, and is suitable for polishing in conduits of fluids such as gases and liquids. Since polishing traces are in the same direction of a passing fluid, an advantage of allowing a fluid to easily pass through is further provided.

Although metal additive manufacturing is capable of manufacturing metal products have complex forms, and complex flow passages and internal structures, these products suffer from a drawback of having rougher surfaces. Thus, a longer machining time is needed to perform machining by using common fluid machining techniques in order to achieve a target roughness.

Fluid machining fixtures of the prior art are mostly fixed single overall structures, and have fixed internal spaces, sizes of flow passages for abrasives and relative positions so as to satisfy abrasive requirements of a predetermined particle size and material. For replacement by an abrasives of different abrasive particles, a fixture having a different flow passage width needs to be used in replacement in order to fully exercise an optimal machining effect of the abrasive. Several fixtures then need to be manufactured for the entire machining process, leading to high costs of fixtures. In addition, in applications of parts in mass production, fixtures can be corroded by abrasives during the machining process and need to be replaced periodically.

For example, the China patent CN 104715110 B provides “method for designing precision polishing mold with equal allowance of abrasive flow for precise and complex curved surface parts” discloses, by designing a width of a flow passage of a fixture, complex surfaces can also be equally and uniformly machined, achieving a machining effect having high uniformity and low variance. However, the machining roughness of the above prior art has a smaller magnitude and is considered to be within a fine processing and machining range. If the above prior art is applied for blanks of workpieces of additive manufacturing, the number of rounds of rough processing or the machining time is necessarily increased. Blanks of workpieces of additive manufacturing need to undergo rough processing to reduce the surface roughness to Ra of 2.0 μm to 1.6 μm, such that not only the transport time overhead of the workpieces is increased, but also the precision of rough processing of curved surfaces cannot be easily managed. That is, requirements of workpieces demanding an extremely high configuration precision cannot be satisfied. If blanks of workpieces of additive manufacturing are directly machined by the fixture designed by the above patent, unfavorable factors including a long machining time, degraded machining efficiency caused by overheating of abrasives and a reduced service life of abrasives can be resulted.

### BRIEF SUMMARY OF THE INVENTION

To improve the drawbacks of the prior art, the present disclosure provides an adjustable fluid machining fixture. In the present disclosure, with a design of a fixture having an adjustable fluid passage, a surface of a workpiece is controlled to be equally machined. Thus, abrasives of different granularities can be used by the same fixture to satisfy multiple rounds of machining, achieving advantages of maintaining a precise size of a curved surface of a workpiece, shortening a machining process time and ensuring a surface machining effect.

An adjustable fluid machining fixture according to the present disclosure includes: a base, having a clamping fixing seat which is used to clamp a workpiece to be machined; at least two guide blocks, disposed above the base and enveloping the workpiece to be machined once assembled to each other, each of the guide blocks provided with a fluid groove on one surface facing the workpiece to be machined, the respective fluid grooves of the guide blocks forming a fluid machining space once the guide blocks are assembled to each other; and at least two limiting units, disposed above the base, the limiting units used to fix the guide blocks and adjust fixed positions of the guide blocks on the base.

In one embodiment of the present disclosure, each of the limiting units is a combination of a chute and a fixed key.

In one embodiment of the present disclosure, a surface of the base is provided with an adjustment scale to accordingly adjust the fixed positions of the guide blocks.

In one embodiment of the present disclosure, the base is provided with a fluid inlet in communication with the fluid machining space.

In one embodiment of the present disclosure, the adjustable fluid machining fixture further includes: an upper cover, disposed on the base and covering the guide blocks and the workpiece to be machined, the upper cover provided with a fluid outlet in communication with the fluid machining space.

In one embodiment of the present disclosure, the fluid machining space is formed in between once the upper cover, the guide blocks and the clamping fixing seat are assembled.

The summary above and the detailed description and drawings below are for better illustrating and understanding the methods and means for achieving expected objects and effects thereof. Other objects and advantages of the present disclosure are also further given in the description below.

### BRIEF DESCRIPTION OF THE DRAWINGS

FIG. 1 is a structural schematic diagram of an adjustable fluid machining fixture according to an embodiment of the present disclosure.

FIG. 2 is a schematic diagram of an upper cover according to embodiment of the present disclosure.

### DETAILED DESCRIPTION OF THE INVENTION

Implementation details of the present disclosure are described by way of specific embodiments for a person skilled in the art to easily and fully understand other advantages and effects of the present disclosure on the basis of the disclosure of the present application.

The adjustable fluid machining fixture of the present disclosure is suitable for a surface process for a finished product processed by additive manufacturing, for example, sanding, polishing and shaping. Due to processing characteristics of additive manufacturing, a surface of workpiece formed by means of sintering is rough, and needs to undergo a surface machining process. In common mechanical processes, the roughness of workpieces is reduced (reduced to Ra of 2.0 μm to 1.6 μm) by manual sandblasting and electrolytic polishing when dealing with workpieces with large roughness differences. However, it is difficult for the above processing to ensure a precise appearance of a workpiece with a curved surface for an integral formed by additive manufacturing. In order to resolve the large difference between initial and target surface roughnesses of a workpiece and maintaining a precise appearance size of a curved surface, the industry tends to use abrasive flow machining (AFM) to machine a surface of a workpiece. The technique uses abrasive particles to contact a surface of a workpiece with an elastic and viscous soft medium, and, by replacing machining fixtures of different sizes and abrasives of different particle sizes, gradually machines the surface roughness of the workpiece from coarse to fine to reach a demanded standard. However, as described previously, the individual rounds of machining need fluid machining fixtures of coarse and fining process in different sizes and standards, and numerous fixtures are required for machining one workpiece in order to achieve a demanded surface roughness of a finished product of the workpiece, resulting in complex and tedious processes and a lengthy operation time. In addition, fixtures are gradually worn over an extended period of use and replacements of new parts are needed, leading to high replacement costs of multiple fixtures.

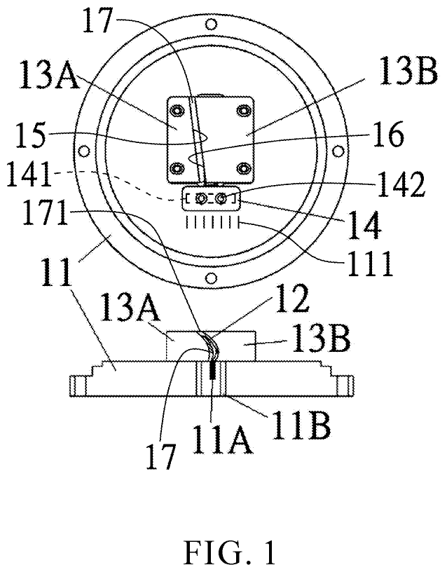

FIG. 1 shows a structural schematic diagram of an adjustable fluid machining fixture of the present disclosure, and shows a top view and a side section view of the adjustable fluid machining fixture. The adjustable fluid machining fixture includes a base 11, provided with a clamping fixing seat 11A which is used to clamp a workpiece 12 to be machined; two guide blocks 13A and 13B, which are disposed above the base 11 and envelope the workpiece 12 to be machined once assembled to each other. The guide blocks 13A and 13B are respectively provided with grooves (flow grooves) 15 and 16 on one surface facing the workpiece 12 to be machined. Once the guide blocks 13A and 13B are assembled, the respective flow grooves 15 and 16 are combined into a fluid machining space 17. Thus, when an abrasive passes through the flow grooves 15 and 16, abrasive particles of the abrasive come into contact and rub against a surface of the workpiece 12 to be machined. The workpiece 12 to be machined is located in the fluid machining space 17. The fluid machining space 17 has an opening 171 on a top (from the perspective of the drawing) for the abrasive (containing abrasive particles) to flow in. Meanwhile, the base 11 is further provided with one or more fluid inlets 11B in communication with the fluid machining space 17, allowing the abrasive to enter the fluid machining space 17 from upper or lower two ends, hence achieving an effect of machining the workpiece 12 to be machined. Two limiting units 14, disposed above the base 11, is used for fixing the guide blocks 13A and 13B, and adjust fixed positions of the guide blocks 13A and 13B on the base 11, so as to further adjust the size of the fluid machining space 17 (that is, a required width of a fluid passage for a specific abrasive) once the guide blocks 13A and 13B are assembled.

The adjustable fluid machining fixture of the present disclosure is used for reciprocal fluid machining. In a conventional approach, a workpiece to be machined is placed in a sealed machining cavity (including a fixture therein to fix the workpiece) having fluid inlets on only two ends to allow an abrasive to repeatedly enter and exit through the two ends. In order to enhance the machining effect, the size and shape of the machining cavity and the distance to the workpiece need to be designed to match the shape of the workpiece, and the type and the granularity of the abrasive. When an initial roughness of a workpiece to be machined differs greatly from a roughness of a utilization requirement, if only one round of the machining process is performed by using a machining fixture in one standard and an abrasive having one granularity, it would be difficult for the roughness of a surface of the workpiece to achieve a target surface roughness, and so replacement of fixtures corresponding to different machining cavities is needed. However, the adjustable fluid machining fixture of the present disclosure, by using the assembled guide blocks 13A and 13B to form a machining cavity (that is, the fluid machining space 17), is capable of adapting to machining requirements of different appearances by merely replacing the guide blocks 13A and 13B of different forms. In addition, the limiting units 14 are added to adjust the positions of the guide blocks 13A and 13B to further change the size of the fluid machining space 17, so as to adapt to fluid width requirements for abrasives of different granularities needed for different rounds of machining including coarse and fine processing.

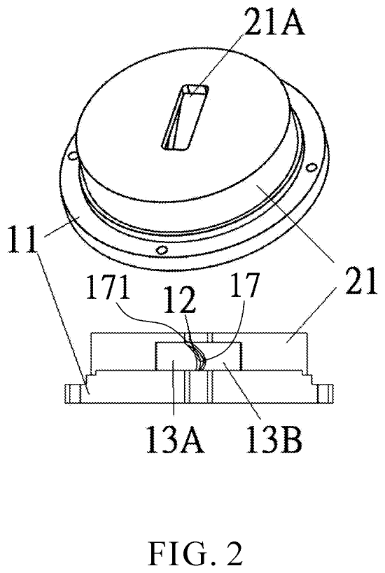

In one embodiment of the present disclosure, the adjustable fluid machining fixture may further include an upper cover 21 disposed on the base 11. As shown in FIG. 2, the upper cover 21 completely covers the guide blocks 13A and 13B and the workpiece 12 to be machined on the base 11, achieving fixing and protection effects. An opening 21A (fluid outlet) is provided on a top of the upper cover 21 and is in communication with the fluid machining space 17 formed by the guide blocks 13A and 13B, so as to allow the abrasive to pass through the opening 21A and enter the fluid machining space 17 to perform a machining process.

In one embodiment of the present disclosure, the fluid machining space 17 is formed once the upper cover 21, the guide blocks 13A and 13B and the clamping fixing seat 11A are assembled. Regarding the fluid machining space 17 formed in between, there is a concern that in an actual application of the present disclosure, the enclosed fluid machining space 17 may not be formed merely by the guide blocks 13A and 13B when the fixing positions (the width of fluid passage) of the guide blocks 13A and 13B are adjusted. Thus, the upper cover 21 can be used as a sealing element to cover the guide blocks 13A and 13B, such that the fluid machining space 17 (with openings allowing the abrasive to enter on the top and the bottom) is formed in between once the upper cover 21, the guide blocks 13A and 13B and the clamping fixing seat 11A are assembled. A user may also add a simple stop block outside the guide blocks 13A and 13B in substitution to the effects provided by the upper cover 21 that encloses the workpiece 12 to be machined, so as to keep the fluid machining space 17 in between in a sealed state for the adjusted guide blocks 13A and 13B.

It should be noted that, the fluid inlet 11B of the base 11 and the fluid outlet 21A of the cover 21 are not meant to limit inbound and outbound flow directions of the abrasive, and a reciprocal machining process in fact involves repeated entering and exiting through two ends. Thus, the inlet and the outlet of the present disclosure are merely terms of elements and are not to be construed as limitations to the direction of the abrasive or machining process.

In one embodiment of the present disclosure, the limiting units 14 are used to fix the positions of the guide blocks 13A and 13B on the base 11. By adjusting the limiting units 14, the object of changing the width of flow passage of fluid machining (the size of the fluid machining space 17) can be achieved to adapt to requirements of abrasives of different types and granularities. The limiting unit 14 of the present disclosure may use a slide key (a combination of a chute 141 and a fixed key 142) with coordination of a predetermined adjustment scale 111 on a surface of the base 11, so as to adjust the fixed positions of the guide blocks 13A and 13B with respect to abrasives of different types and granularities. Thus, multiple rounds of machining including coarse machining and fine machining can be satisfied by merely using one set of adjustable fluid machining fixture of the present disclosure. Other types of adjustable fixing devices can also be used in the present disclosure, for example, difference devices such as screw holes, sliding tracks and step motors. Provided that the spirit of the width of machining flow passage is changed by adjusting the guide blocks 13A and 13B of the present disclosure, such modifications are to be encompassed within the scope of the present disclosure.

The elements including the guide blocks 13A and 13B, the limiting units 14, the clamping fixing seat 11A and the upper cover 21 of the present disclosure are in assembled designs, and a user may make substitutions to the above by elements of different types and materials to adapt to different machining purposes. Regarding to wear of parts of the adjustable fluid machining fixture of the disclosure over an extend period of use or after machining mass amounts of workpieces, only the worn parts need to be replaced instead of having replace the entire fixture, hence providing better economical advantages.

In one embodiment of the present disclosure, taking two rounds of machining including coarse machining and fine machining for example, machining steps implemented can be divided into a coarse processing step and a fine processing step, with details of the implemented steps as below.

1. Coarse processing: an abrasive for the coarse processing (an abrasive having a larger abrasive granularity selected from various types of abrasives) is filled into a machine tank of a fluid machining device, the workpiece 12 to be machined is installed onto the clamping fixing seat 11A of the fixture, the left and right guide blocks 13A and 13B are adjusted to align with the adjustment scale 111 (width of flow passage) shown in the base 11 in coordination with the abrasive for the coarse processing (an abrasive having a larger abrasive granularity selected from various types of abrasives), and once the width of flow passage between the guide blocks 13A and 13B and the workpiece 12 to be machined is determined, the workpiece 12 to be machined and the fixture are moved to a machining position and fixed to start machining.

2. Fine processing: once the coarse processing is complete, the workpiece 12 to be machined having undergone the coarse processing and the fixture are taken out and cleaned, the abrasive for coarse processing is replaced by an abrasive for fine processing, the workpiece 12 to be machined having undergone the coarse processing is installed onto the clamping fixing seat 11A of the fixture, the width of flow passage is adjusted in coordination with the abrasive for the fine processing, and the workpiece 12 to be machined having undergone the coarse processing and the fixture are moved to a machining position and fixed to start machining. When the machining step of fine processing is complete, the workpiece 12 to be machined having undergone the fine processing and the fixture are taken out and cleaned, thus obtaining a finished product of the workpiece.

Accordingly, the present invention provides an adjustable fluid machining fixture, and reduces the overall costs of machining processes for a workpiece without having to manufacture multiple fixtures. The adjustable assembled fluid machining fixture of the invention implements a fluid machining method including coarse processing and fine processing with the coordination of abrasives of different abrasive granularities, wherein the coarse processing quickly reduces the surface roughness of a workpiece and provides effects of shortening the machining time and reducing loss of abrasive particles of the abrasive, and the fine processing achieves a target roughness for a surface of the workpiece. With the adjustable assembled fluid machining fixture of the invention, for damage of the fixture after numerous machining processes performed by the fixture, only a damage part needs to be replaced instead of having to again manufacture the entire fixture, hence reducing subsequent fixture maintenance costs.

It should be noted that, the embodiments described above are merely examples for illustrating the features and effects of the present invention, and are not to be construed as limitations to the substantial technical contents of the present invention. Without departing from the spirit and scope of the present invention, modifications and variations may be made to the embodiments above by a person skilled in the art. Therefore, the scope of protection of the present invention should be accorded with the broadest interpretation of the appended claims.

What is claimed is:

1. An adjustable fluid machining fixture, comprising:
a base, provided with a clamping fixing seat which is used to clamp a workpiece to be machined;
at least two guide blocks, disposed above the base and enveloping the workpiece to be machined once assembled to each other, each of the guide blocks provided with a fluid groove on one surface facing the workpiece to be machined, wherein the respective fluid grooves are combined into a fluid machining space once the guide blocks are assembled to each other; and
at least two limiting units, disposed above the base, used to fix the guide blocks and adjust fixed positions of the guide blocks on the base.

2. The adjustable fluid machining fixture according to claim 1, wherein each of the limiting units is a combination of a chute and a fixed key.

3. The adjustable fluid machining fixture according to claim 1, wherein a surface of the base is provided with an adjustment scale to accordingly adjust the fixed positions of the guide blocks.

4. The adjustable fluid machining fixture according to claim 1, wherein the base is provided with a fluid inlet in communication with the fluid machining space.

5. The adjustable fluid machining fixture according to claim 1, further comprising:
an upper cover, disposed on the base and covering the guide blocks and the workpiece to be machined, the upper cover provided with a fluid outlet in communication with the fluid machining space.

6. The adjustable fluid machining fixture according to claim 5, wherein the fluid machining space is formed in between once the upper cover, the guide blocks and the clamping fixing seat are assembled.
